(19) United States
(12) Patent Application Publication
(10) Pub. No.: US 2013/0104034 A1
(43) Pub. Date: Apr. 25, 2013

(54) SYSTEM AND METHOD OF PROVIDING OFF-NETWORK ACCESS TO NETWORK CONTENT

(71) Applicants: Benjamin Clayton Ashpole, North Webster, IN (US); Jay Alan Olman, Philadelphia, PA (US)

(72) Inventors: Benjamin Clayton Ashpole, North Webster, IN (US); Jay Alan Olman, Philadelphia, PA (US)

(21) Appl. No.: 13/650,747

(22) Filed: Oct. 12, 2012

Related U.S. Application Data
(60) Provisional application No. 61/547,128, filed on Oct. 14, 2011.

(51) Int. Cl. G06F 17/22

(52) U.S. Cl. CPC G06F 17/2247
USPC 715/239

(57) ABSTRACT

A system and method of creating a data file of network content is provided. The method includes downloading a plurality of HTML webpages from a network, at least one of the webpages including text content and non-text content; converting the plurality of HTML web-pages into unformatted text-only content; and compressing the unformatted text-only content; archiving the compressed unformatted text-only content; wherein a desired webpage of the plurality of webpages can be obtained from the archive via decompression to provide a text-only version of the desired webpage.

### CROSS REFERENCE TO RELATED APPLICATIONS

The instant application claims priority to U.S. 61/547,128, entitled ENGINE, SYSTEM AND METHOD OF PROVIDING FEATURES INCLUDING OFF-NETWORK ACCESS TO NETWORK CONTENT, filed on Oct. 14, 2011, the contents of which are incorporated by reference herein in its entirety.

### FIELD OF THE INVENTION

The present invention relates generally to accessing network content, and more particularly relates to an engine, system and method of providing off-network access to network content.

### BACKGROUND

The Internet contains an ever-growing wealth of information. Anyone with Internet access can add content, regardless of value, creating an unabridged encyclopedia of enormous proportions, much greater than the amount of information available in all of the world's physical libraries. People use the Internet to access a wide variety of useful information and entertainment content. A 2010 study by Google found that of what is considered the “surface web”—those sites that are able to be indexed by crawler search engines—contains 4.2 billion web sites, 380 million of which are considered presently “useful.” The “deep web,” on the other hand, which contains dynamically-generated content, non-text content, and other information unable to be indexed, contains approximately 40 times the amount of information available on the known surface web (Kumar, et al., http://scr.bi/qMozkS). However, as of Mar. 31, 2011, 69.8% of the world's population, including 88.6% of Africa and 76.2% of Asia did not have a regular Internet connection and cannot access this large amount of information (http://www.internetworldstats.com/stats.htm). In May of 2011, the United Nations declared Internet access a human right and urged all governments to try to give their citizens affordable access. Unfortunately, the infrastructure and equipment required for Internet access can be prohibitively expensive for both potential users and potential service providers.

Despite the always-increasing computer storage capacity, the amount of information on the Internet grows at a much larger rate. Previous solutions to offline Internet browsing are severely limited because a user must have previously visited or must specify a web page to capture for later viewing. Furthermore, the amount of Internet content that can be stored is limited by the page size. It was inconceivable that wide-ranging, offline Internet browsing without predetermining exact sites or topics to store was possible with previous solutions.

U.S. Pat. No. 6,757,683 to Goodwin, et al. (2004) shows a method of downloading a specified web page and linked content to a specified depth in order to increase browsing speed. However, this requires that a user specify an initial web page from which to provide linked content and does not allow for unanticipated browsing. Another problem is that this method requires an active Internet connection.

U.S. Pat. No. 6,507,867 to Holland, et al. (2003) shows a method of downloading web pages for access in the absence or temporary interruption of an Internet connection. The problem with this is that a user must preselect which site or sites he wants to begin with and provides extremely limited access to the Internet as a whole. It is not likely that a user knows in advance what he will want to view.

U.S. Pat. No. 6,096,096 to Murphy, et al. (2000) shows a method of emulating an Internet connection by storing a web site for access in an offline environment. However, it only involves a single web site. While this simulates a live connection for one web site, it does not allow for breadth in browsing.

U.S. Pat. No. 6,182,122 to Berstis (2001) shows a method of minimizing required connection time by pre-caching web pages that a specific group of users is likely to visit based on their previous activity. This does not allow for unanticipated browsing from users. Furthermore, it requires an active Internet connection.

### SUMMARY

In accordance with an embodiment, a condensed off-network archive of network content comprises advantageously packaging a version of the whole Internet on a single device for use while it is not connected to the Internet. This is accomplished by examining the extents of data available on the Internet, determining the usefulness of the data elements, storing a reduced-fidelity version of the useful data, compressing the useful data, and indexing it for later retrieval. This way, compared to the size of the entire raw Internet, a “lossy-compression factor” of a billion (that is, modified data that is 1 billion times smaller than the original data) can be achieved that surprisingly still yields a vast array of valuable information.

Accordingly, several advantages of one or more optional aspects are as follows: to simulate a network connection that allows a user to browse the breadth of the Internet in an offline situation; to remove content from web pages that is unnecessary or extraneous to the information on any particular page; and to provide a completely safe, secure, and private way to access and browse Internet-based data. Other advantages of one or more aspects will be apparent from a consideration of the drawings and ensuing description.

### DESCRIPTION OF THE DRAWINGS

The accompanying drawings are included to provide a further understanding of the disclosed embodiments. In the drawings, like numerals represent like elements, and:

FIG. 1 is a block diagram illustrating an exemplary computing system for the use of the present invention;

FIG. 2 is a block diagram illustrating an exemplary networked computing environment;

FIG. 3 is a block diagram of a system for creating a condensed off-network archive of network content made up of HTML files;

FIG. 4 is a block diagram of a file recovery architecture of a condensed off-network archive of network content;

FIG. 5 is a block diagram of a file recovery architecture when the condensed off-network archive of network content includes HTML files;

FIG. 6 is a flow diagram for recovery of a file within a condensed off-network archive of network content;

FIG. 7 is a block diagram of a system for creating a condensed off-network archive of network content with the added feature of filtering content to be removed;

FIG. 8 is a diagram of the interaction of multiple users' condensed off-network archives of network content, of multiple versions, connected via a local area network;

FIG. 9 is a flow diagram of the recovery of a file from multiple users' condensed off-network archives of network content of multiple versions, connected via a local area network;

FIG. 10 is a flow diagram for the recovery of a file within a condensed off-network archive of network content with active, user-specified, post archive-creation content filtering;

FIG. 11 is a block diagram for creating a condensed off-network archive of network content with the added feature of an authentication database to determine who is allowed to view what protected content;

FIG. 12 shows a flow chart for a condensed off-network archive of network content with the added feature of storing interactive data for use when a connection or update is available; and

FIG. 13 is a block diagram for creating a condensed off-network archive of network content with the added feature of only storing summaries of web pages.

### DETAILED DESCRIPTION

Computer-implemented platforms, engines, systems and methods of use are disclosed that provide networked access to a plurality of types of digital content, including, but not limited to video, audio, metadata, interactive and document content, and that may track, deliver, manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

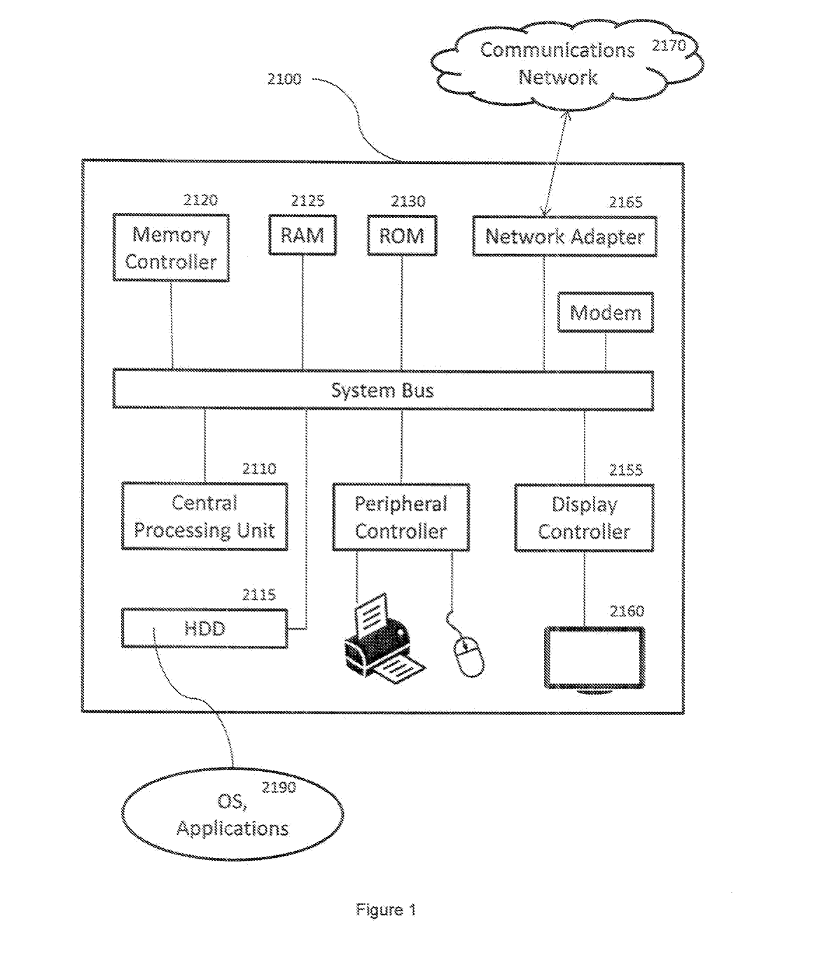

FIG. 1 depicts an exemplary computing system 2100 for use in accordance with herein described system and methods. Computing system 2100 is capable of executing software, such as an operating system (OS) and a variety of computing applications 2190. The operation of exemplary computing system 2100 is controlled primarily by computer readable instructions, such as instructions stored in a computer readable storage medium, such as hard disk drive (HDD) 2115, optical disk (not shown) such as a CD or DVD, solid state drive (not shown) such as a USB “thumb drive,” or the like. Such instructions may be executed within central processing unit (CPU) 2110 to cause computing system 2100 to perform operations.

It is appreciated that, although exemplary computing system 2100 is shown to comprise a single CPU 2110, such description is merely illustrative as computing system 2100 may comprise a plurality of CPUs 2110. Additionally, computing system 2100 may exploit the resources of remote CPUs (not shown), for example, through communications network 2170 or some other data communications means.

In operation, CPU 2110 fetches, decodes, and executes instructions from a computer readable storage medium, such as HDD 2115. Such instructions can be included in software such as an operating system (OS), executable programs and applications, and the like. Information, such as computer instructions and other computer readable data, is transferred between components of computing system 2100 via the system's main data-transfer path. The main data-transfer path may use a system bus architecture 2105, although other computer architectures (not shown) can be used, such as architectures using serializers and deserializers and crossbar switches to communicate data between devices over serial communication paths. System bus 2105 can include data lines for sending data, address lines for sending addresses, and control lines for sending interrupts and for operating the system bus. Some busses provide bus arbitration that regulates access to the bus by extension cards, controllers, and CPU 2110. Devices that attach to the busses and arbitrate access to the bus are called bus masters. Bus master support also allows multiprocessor configurations of the busses to be created by the addition of bus master adapters containing processors and support chips.

Memory devices coupled to system bus 2105 can include random access memory (RAM) 2125 and read only memory (ROM) 2130. Such memories include circuitry that allows information to be stored and retrieved. ROMs 2130 generally contain stored data that cannot be modified. Data stored in RAM 2125 can be read or changed by CPU 2110 or other hardware devices. Access to RAM 2125 and/or ROM 2130 may be controlled by memory controller 2120. Memory controller 2120 may provide an address translation function that translates virtual addresses into physical addresses as instructions are executed. Memory controller 2120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

Display 2160, which is controlled by display controller 2155, can be used to display visual output and/or presentation generated by or at the request of computing system 2100. Such visual output may include text, graphics, animated graphics, and/or video, for example. Display 2160 may be implemented with a CRT-based video display, an LCD-based flat-panel display, gas plasma-based flat-panel display, touch-panel, or the like. Display controller 2155 includes electronic components required to generate a video signal that is sent to display 2160.

Further, computing system 2100 may contain network adapter 2165 which may be used to couple computing system 2100 to an external communication network 2170, which may include or provide access to the Internet. Communications network 2170 may provide user access for computing system 2100 with means of communicating and transferring software and information electronically. Additionally, communications network 2170 may provide for distributed processing, which involves several computers and the sharing of workloads or cooperative efforts in performing a task. It is appreciated that the network connections shown are exemplary and other means of establishing communications links between computing system 2100 and remote users may be used.

It is appreciated that exemplary computing system 2100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

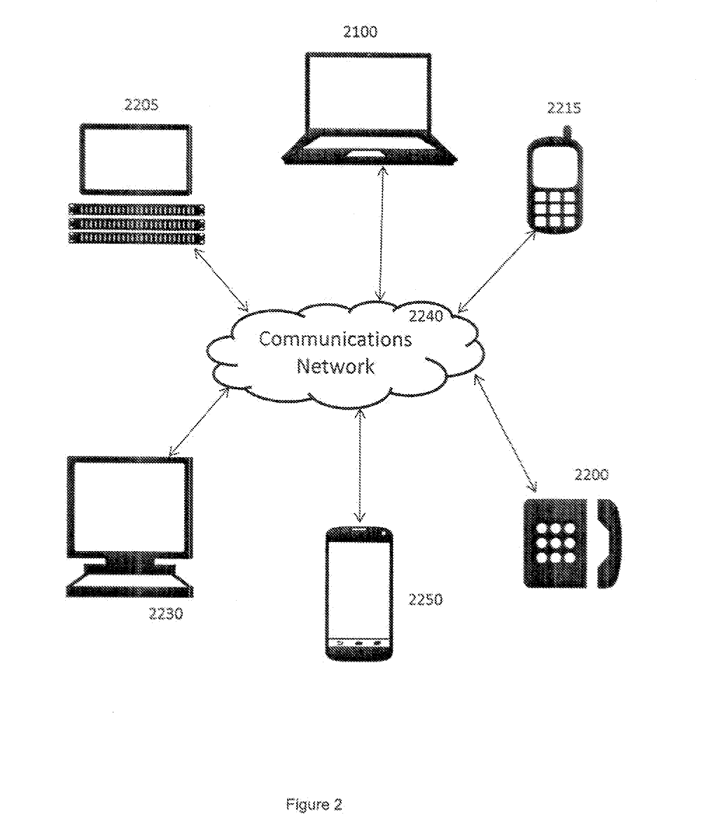

As shown in FIG. 2, computing system 2100 can be deployed in networked computing environment 2200. In general, the above description for computing system 2100 applies to server, client, and peer computers deployed in a networked environment, for example, server 2205, laptop computer 2210, and desktop computer 2230. FIG. 2 illustrates an exemplary illustrative networked computing environment 2200, with a server in communication with client computing and/or communicating devices via a communications network.

As shown in FIG. 2, server 2205 may be interconnected via a communications network 2240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 2210, wireless mobile telephone 2215, wired telephone 2220, personal digital assistant 2225, user desktop computer 2230, and/or other communication enabled devices (not shown). Server 2205 may comprise dedicated servers operable to process and communicate data such as digital content 2250 to and from client devices 2210, 2215, 2220, 2225, 2230, etc. using any of a number of known protocols, such as hypertext transfer protocol (HTTP), file transfer protocol (FTP), simple object access protocol (SOAP), wireless application protocol (WAP), or the like. Additionally, networked computing environment 2200 may utilize various data security protocols such as secured socket layer (SSL), pretty good privacy (PGP), virtual private network (VPN) security, or the like. Each client device 2210, 2215, 2220, 2225, 2230, etc., may be equipped with an operating system operable to support one or more computing and/or communication applications, such as a web browser (not shown), email (not shown), or the like, to interact with server 2205.

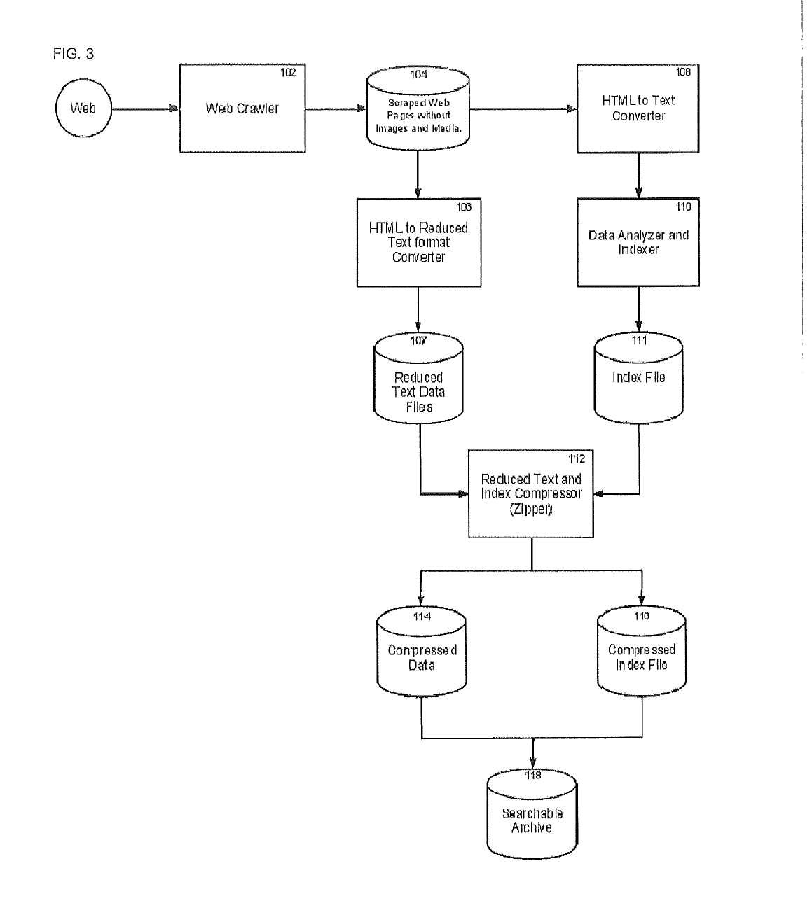

FIG. 3 illustrates a first exemplary embodiment of the construction of a condensed off-network archive of network content. In order to create a condensed off-network archive of network content, the content is searched and downloaded. For ease of discussion, reference is made herein to the non-limiting example of the Internet, but it is to be understood that the methodologies apply equally well to intranet and other network environments.

By way of non-limiting example, a web crawler 102 crawls the Internet and downloads pages to a storage location 104. Generally, the crawler software starts with a list of seed URLs or enumerates IP addresses, retrieves the contents of these locations, identifies any links within the content, follows those links, and repeats the process with the next page. Known crawling products such as HERITRIX OR NUTCH could be used for this purpose, although the invention is not limited and other search methodologies (crawling and non-crawling) could be used.

When the searched content is the Internet, under current methodology the content will be HTML web pages. An HTML-to-reduced text format converter 108 converts the HTML files (as received and/or after placed into storage 104) into a reduced text format 107 for later reading. An HTML-to-text converter 106 eliminates formatting, enabling a data analyzer and indexer 110 to examine the downloaded files, and create an index file 111 for them to be searched. This type of filtering is already performed by existing methods, such as w3m or other text-based browsers, wiki-code conversion, or other HTML-to-text converters, such as html2text or HTMLAsText.

Both the reduced text files 107 and index file 111 are compressed using by way of non-limiting example a zipper 112 (or some other compression algorithm) to further reduce the size of the content. Data compression is a well-known process for those familiar with the art and existing software for achieving this, such as 7Zip or bzip2, can be used. Further compression can be achieved by storing the reduced contents of multiple network files within a single file, which then resides in an archive. The resulting compressed data files 114 and compressed index file 116 comprise an archive 118 that can later be searched or browsed. The invention is not limited to any particular compression and/or indexing methodology.

As part of the above processing, preferably not all web page content is preserved. For example, audio, video, graphics and/or picture content requires typically significantly more storage capacity than text, and thus is not included within the reduced text files 107. Such high capacity content can be filtered or removed at any of the prior steps as appropriate. For example, the web crawler 102 may simply not return such content, or remove the content from the downloaded data based on, e.g., file extensions. The HTML-to-reduced text format converter 108 similarly would not convert these types of non-text information into text.

In another embodiment of the invention, rather than not preserving audio, video and/or picture data, the system may convert such data into a lower capacity form. By way of non-limiting example, a picture could be converted into a smaller and/or lower resolution version of itself, and the lower capacity version could then be subject along with the text to compression for preservation.

According to another embodiment of the invention, identified data is only preserved if it is considered “useful.” Downloaded data would only be preserved in reduced text files 107 if the data was considered sufficiently useful relative to some metric; anything that did not satisfy a threshold of the metric would not be preserved. In the alternative, there could be multiple thresholds that affect the nature of the preservation; for example, data that is considered highly useful might have some non-text content preserved (preferably in reduced format as above), data that is of moderate usefulness may only have text preserved, etc.

The implementation of the decision to disregard data of low usefulness can come at any point in the processing. Thus for example, the webpage may not be downloaded in the first place; it may be downloaded but not converted to a lower fidelity format; it may be converted but not indexed. Ultimately, regardless of when implemented, such data would not be included in archive 118.

One metric of whether data is useful is the “rank” of a web page. By way of non-limiting example, various web pages are “ranked” using methods that are known in the art such as PAGERANK, hyperlink-induced topic search (HITS), or term frequency-inverse document frequency (tf-idf). Thus, a high rank may indicate that a particular webpage is considered useful to the public; data that is ranked above a certain threshold could thus be treated differently than data ranked below the threshold. By way of non-limiting example, a web page ranked above the threshold could be ultimately stored in file 107 a discussed herein, while a web page ranked below would be ignored and not preserved.

A concern with using rank relate to the fact that page ranking is based on all content of the page, inclusive of audio and video. Rank could be completely different if the non-text elements were removed. For example, a web page on YOUTUBE of a video may have a high rank, but the page would be ultimately undesirable if the video were not available. This simply could be accepted as part of the system. However, various options are available to address this concern. One such option is to pre-designate and exclude sites that focus on non-text content, such as YOUTUBE, regardless of ranking. Another option is to re-rank the returned site under the assumption that it will be stripped of formatting or graphics (if applicable) or under assumptions about what language or topic an end user prefers or prefers to avoid.

Those skilled in the art will appreciate, in light of the discussion herein, that although HTML may be used in the discussion herein by way of reference, the present invention may be similarly operable with other programming technologies, including, but not limited to, markup language text, scripts, and the like.

Once the desired data is converted into archive 118, it can be stored on any non-transitory computer readable medium and transported. The content can thus be brought to areas that may lack access to the Internet, and can be used by residents of that area to access at least the text based content of useful Internet sites.

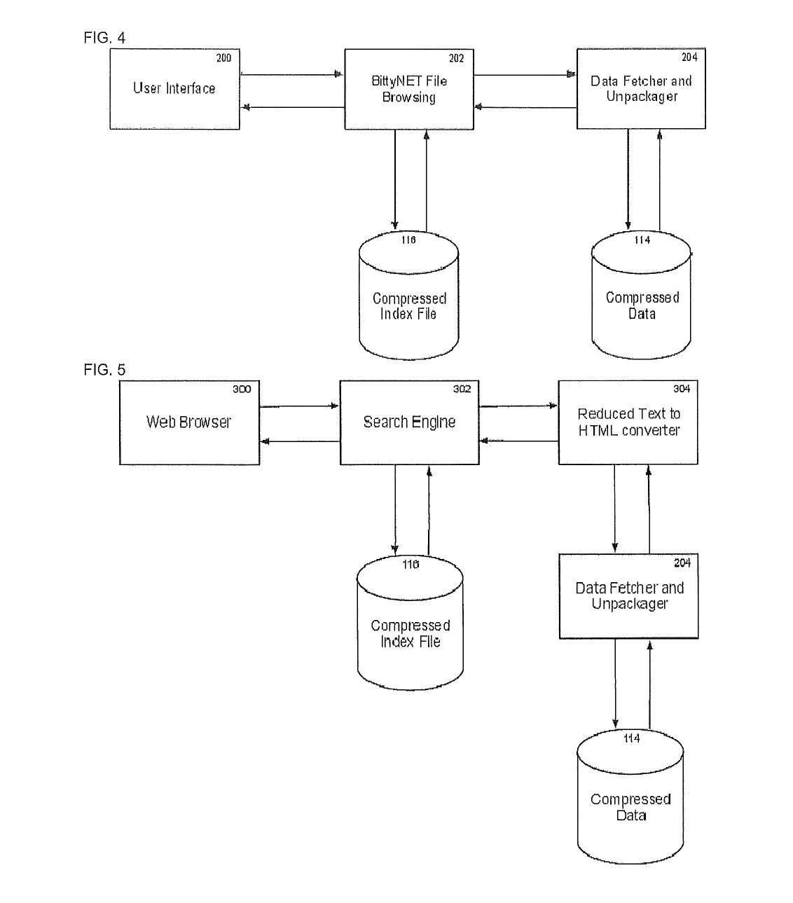

FIG. 4 shows an exemplary client-side architecture of a condensed off-network archive of network content. A file browser 202 receives a search query from a user interface 200. It checks against the index 116 for the search term(s) and, when found, sends a request to a data fetcher 204 to find and uncompress the desired data file from the compressed data 114. File browser 202 then receives the unzipped data and returns it to the user interface 200 for access.

FIG. 5 further shows the exemplary client-side architecture in the case of the archive consisting of HTML files. In this instance, after the data fetcher 204 receives the request for data from a web browser 300 in the same way as in a non-HTML case, but it then returns the data to a reduced-text-to-HTML converter 304 that reconstructs the file with the proper formatting for viewing by the user of web browser 300 and sends it there to be viewed.

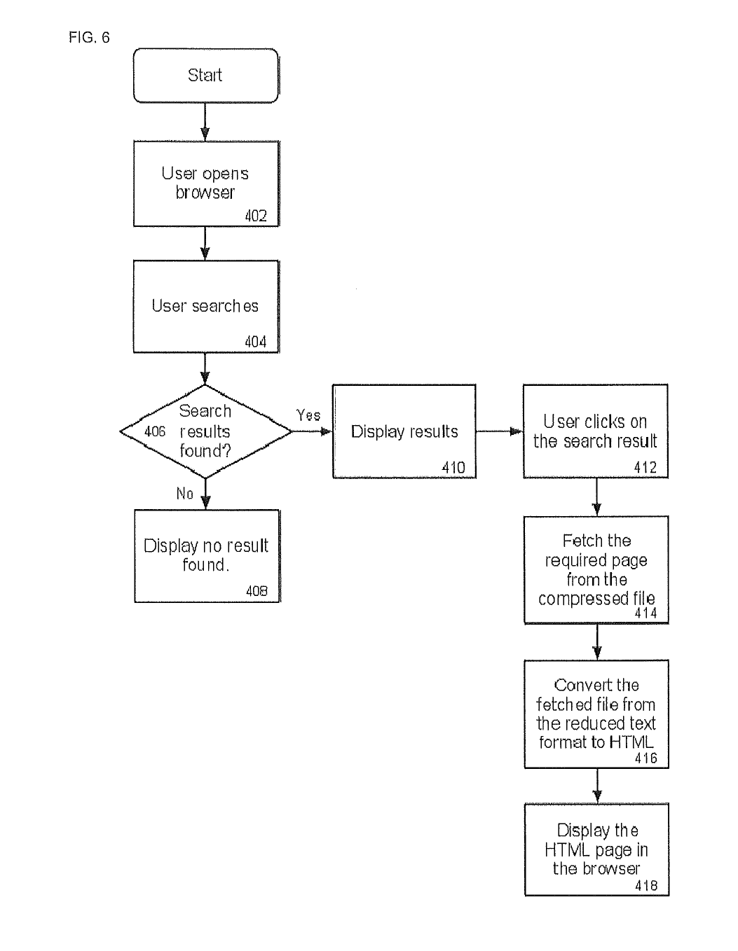

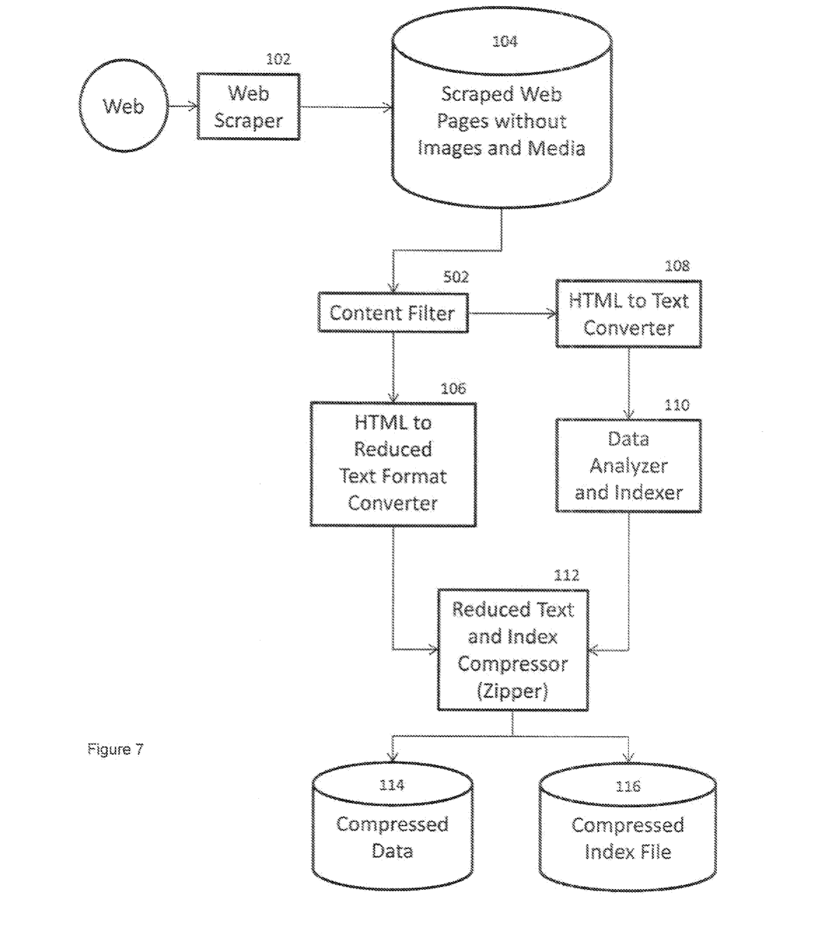

FIG. 6 shows a flowchart of an exemplary operation of a condensed off-network archive of network content by a user in the situation where the network being archived is the Internet. In steps 402 and 404, the user opens her web browser, navigates to the search engine, and enters a search term, just as she would do with an active connection at a site such as Google or Yahoo. In step 406, the index is searched for the user-entered term to see if it is part of the archive. If no match is found, the user will receive a message indicating this, as shown in step 408. In this case, the user might be given a list of the closest incorrect indexed terms, in case those results would be adequate. If a match is indeed found, the results are displayed in a list in step 410. In step 412, the user then selects the most relevant or desired of the search results. The system then fetches the required page from the compressed file in step 414. In step 416, the system converts the desired file from its reduced text format into HTML. This may be done in a variety of ways, the easiest of which is using an HTML-to-reduced text converter to go back to HTML. Finally, in step 418, the HTML page is displayed in the browser for use by the operator.

Of course, those skilled in the pertinent arts will appreciate, in light of the discussion herein, that there are various possibilities with regard to the amount and nature of the content stored in a condensed off-network archive of network content. It is conceivable that the volume of content will be pared down based on the amount of storage space available. This may be implemented in a variety of ways, including, but not limited to: by content importance, as determined by the ranking step; by language, to only include files written in a specific language or languages; based on a user's location, in order to have content that is most useful or relevant; based on what information a user states in advance he or she would like to prioritize; by analysis of the content in order to determine the most information-dense files by determining what amounts of advertisements or junk that is of little or no value to a user; and by the identification and elimination of duplicate information. FIG. 5 shows the method for creating a condensed off-network archive of network content with the added feature of reducing the amount of content. This is accomplished by using a filter 502 before the HTML-to-reduced text format or the HTML-to-text steps, in order to remove or limit undesired files or content.

Another embodiment allows users on multiple devices to communicate with one another, enabling a larger amount of information to be accessed because of an increased total storage capacity. Newcomers to the group network might likely have updated, more current information or more specific information about a particular topic. A user is able to browse on his own device, as well as on the devices of others, if necessary, based on a user's preferences for power or battery usage, preference for number of search results, the age of the data available, and network bandwidth and latency. FIG. 8 shows a block diagram for the exemplary use of a condensed off-network archive of network content across multiple devices on a local area network (LAN). A User 1 602 and a user 2 604 are both connected to the LAN router, and a user 3 606 and a user 4 608 are connected to it wirelessly. User 2 604 has a recent version of a condensed off-network archive of network content 610, while user 3 606 has an older version 612. All users of the LAN are able to search and browse both of the archives simultaneously and seamlessly. With more versions of the archive present, especially with Internet archives or other frequently-changing networks, a user can have a more complete picture of the network, including the ability to see how files have changed over time by comparing an old version 612 to a new version 610, user 3 606 can update his archive to include any newer file versions, as desired. Assuming the same file size, it is also likely that user 2 604 will not have certain information that user 3 606 does, especially in the case of an Internet archive, and she is able to choose to add or replace information as desired from the older version. It is also conceivable that user 1 602 and user 4 608, who did not previously have copies of any version of the network, to copy to their own systems those networks accessible from the LAN.

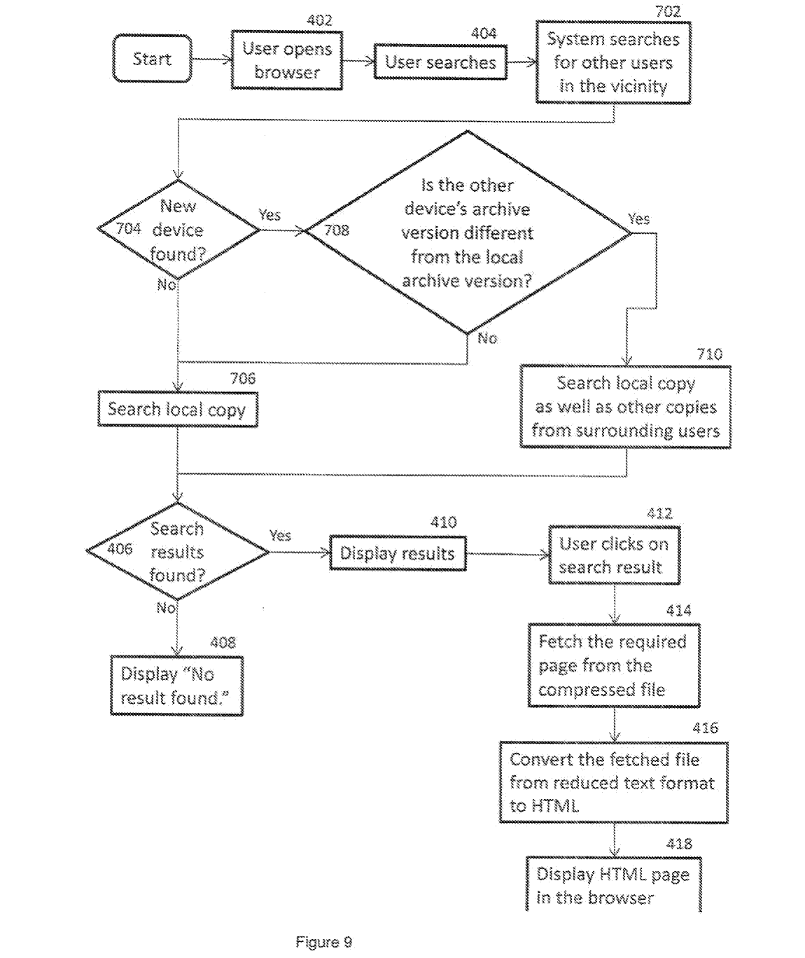

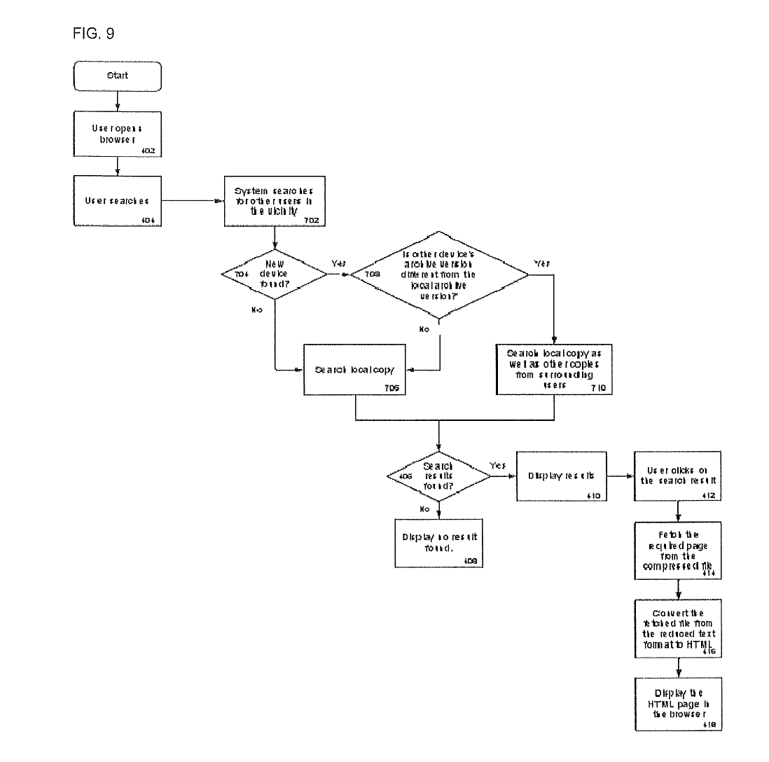

FIG. 9 shows a flow chart for the use of this multiple-device system. By way of non-limiting example, it may differ from a one-device process as follows: after a user chooses to search or browse, the condensed off-network archive of network content checks to see if there are other archives in the vicinity in step 702, connected to the same network. In step 704, if no other archives are found, the process proceeds as normal with step 706. However, if another device is found, in step 708 the user's system checks whether the archive is different from the user's version. If it is identical, then the user's system only searches itself, proceeding with step 706. If the other archive is different—larger, newer, older, content-focused, etc.—then the system goes to step 710 and searches and displays results from both archives. As well, if there are multiple archives present, the system searches and returns results from each unique archive connected to the network. After results are displayed, the process is the same as it is with only one device.

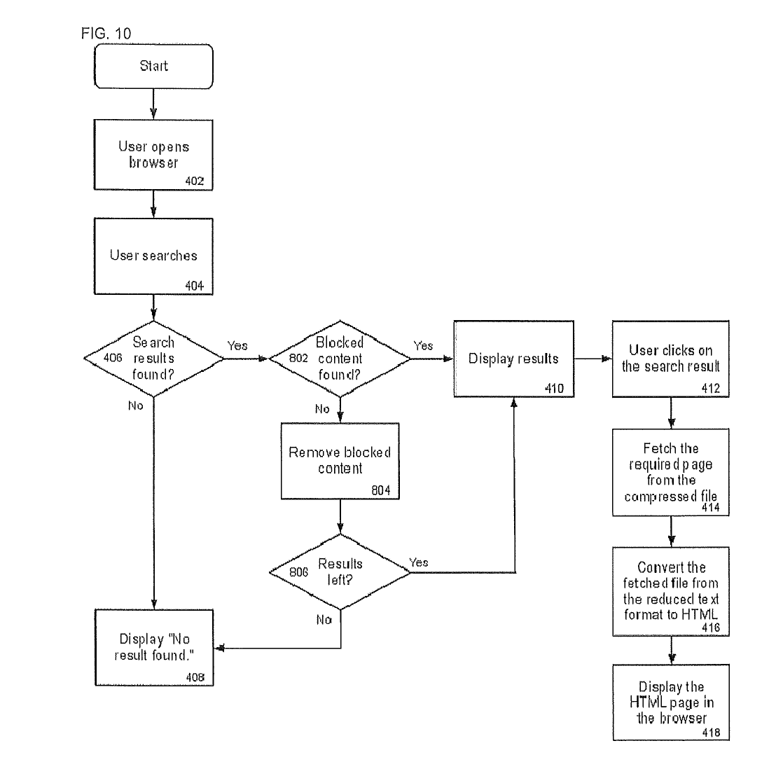

Another embodiment adds a content filter in order to block certain content from users, specified by an administrator. FIG. 10 is a flow chart showing how an active content filter may work to block certain content from being recovered from a condensed off-network archive of network content. In step 802, if search results are indeed found, the system checks for whether any of the results included content intended to be blocked by an administrator, whether a parent, teacher, office manager, etc. If the results are safe and do not include any disallowed content, the process continues and the results are displayed. However, if blocked content is included in the original search results, step 804 removes those results from the list. Then, in step 806, the system checks whether there are any results remaining after the blocked ones are removed. If not, then “No results found” is displayed in step 408, but if so, then the process proceeds with the display of results in step 410.

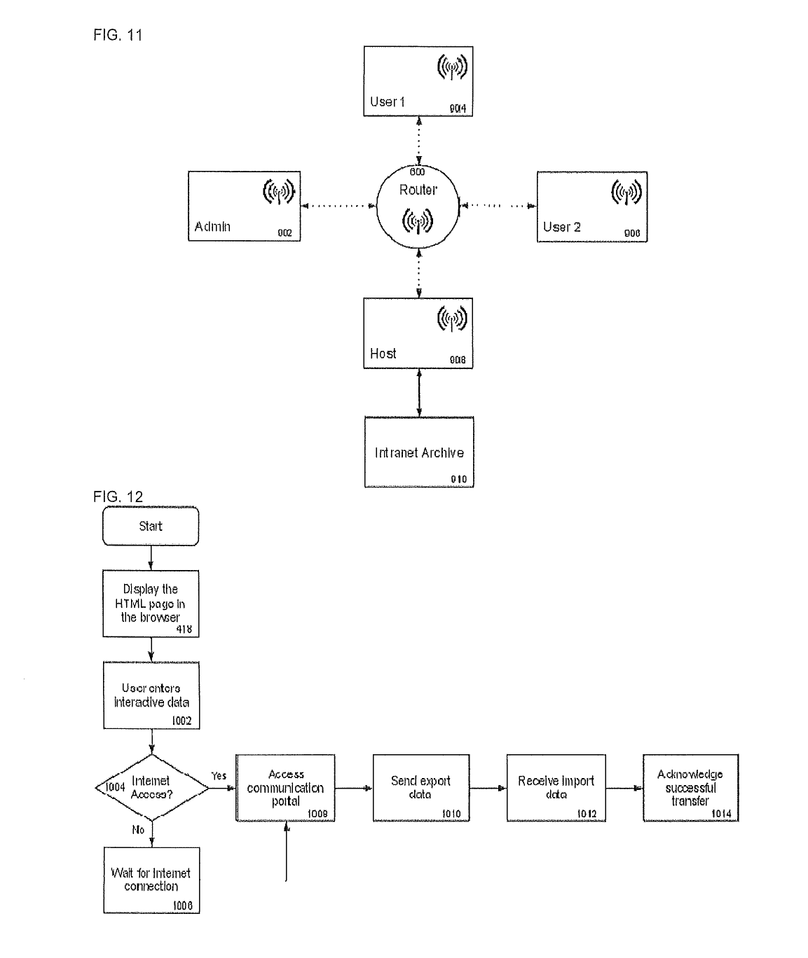

FIG. 11 is a block diagram depicting an exemplary intranet version of a condensed off-network archive of network content with an authentication database included so that users are only able to access certain files. Wireless router 600 connects all of the users, regardless of level of access, to a host 908 of the network, which may be, but is not limited to, a single copy of a condensed off-network archive of network content with an additional user authentication database included or a larger local server. Those of skill in the art will recognize that it is not imperative that a wireless router be used to connect the users and that they may interact through some other networking system, either connecting to a hub or directly to the host. Host 908 either contains or is connected to a condensed off-network archive of network content 910. A system administrator 902 is able to log in to the copy of the intranet using her unique user name and password. A user 1 904 and a user 2 906 are also able to access archive 910 with user names and passwords, but they are only able to view files that they have permission to view in the regular, original version of the intranet.

Another embodiment may have the ability to store interactive websites that require an online connection or to interact with websites that might not be anticipating interacting in an offline manner. The system stores inputs to web pages for use in a variety of ways. One way is to store inputs in a holding file until an Internet or network connection is available and submitting the inputs to the proper sites at that time when allowed, either automatically or manually. Another way is to store input information in an interaction file to be exported to a location or new computer system that has an available Internet or network connection. A new archive is then obtained with the results of such interactions, including but not limited to: requests for video, audio, images, or other media; shopping results; votes or surveys; and bank information. Another way this may work in a case in which inter-device communication is available between multiple users is for every user's device to store requests from all or a certain number of other users to be then submitted to the proper web sites or networks when someone has a connection. Another way is to send all requests across local networks until they reach a user with an active connection. Regardless of the actual implementation of the data transfer, FIG. 12 is a flowchart showing the use of a condensed off-network archive of network content with the added feature of exporting and importing data when a network connection becomes available. As the user is viewing an HTML page in step 418, it is likely that he will encounter pages that ask for interactive data, such as placing an order for something, subscribing to an email list, or even sending email messages. In step 1002, the user enters the interactive data to be sent to the website. In step 1004, the system checks to see if there is an active Internet connection available. If not, the system, in step 1006, waits and does nothing with the data until a connection is indeed available. When the connection is available, in step 1008, the system accesses a website that serves as a communication portal, which will then, in step 1010, distribute the user-entered data to the various websites or locations. In step 1012, the system waits until any result files or confirmations are received. Then, the system acknowledges a successful transfer to the user in step 1014, making available or displaying all confirmations or result files and storing them for later access. Of course, this process also works with non-Internet networks and with other types of connection. Those skilled in the art will appreciate that the present invention thereby provides a solution to the data loss, input loss, or the like that typically occurs when a browser reaches a connection time out due to an inability to access a requested domain/page.

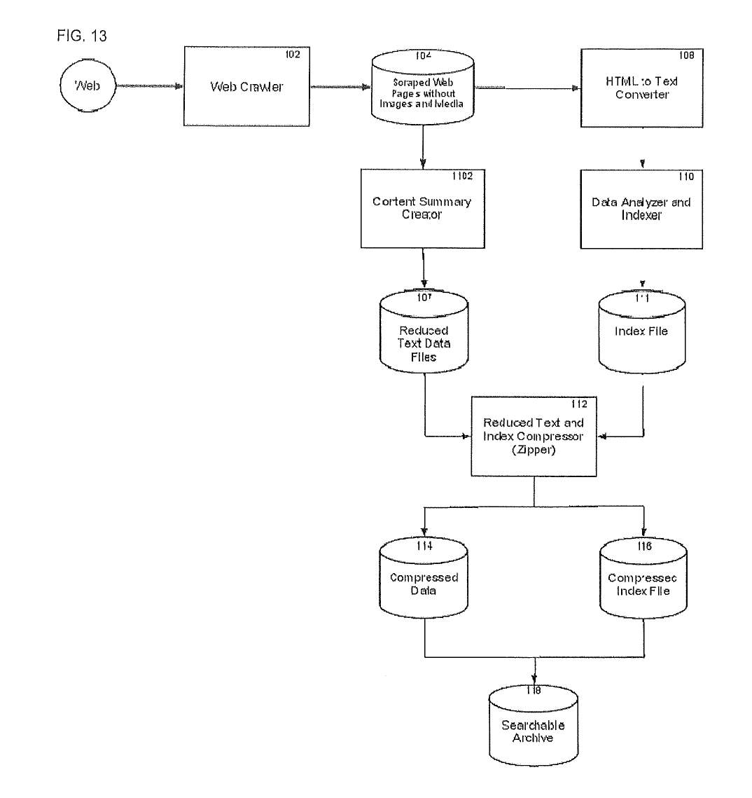

Another embodiment involves the storage not of the complete text of web pages, but of short summaries of pages or files. As such, a category, such as “all world news,” may be made available to a user, wherein rather than reading a single site for news, summaries of the news from the 100 most popular news sites may be provided to the user. Further, this enables many more sites to be stored and may serve as a to-do list creator, cataloging sites to be visited when a connection is available. FIG. 13 is a block diagram of the creation of a condensed off-network archive of network content in which only summaries are stored. The entire process is very similar to that of storing regular HTML pages except that instead of converting the HTML file to another text format, a content summary creator 1102 is used to generate only a short summary of the text. The index and storing processes remain the same.

As such, and by way of non-limiting reference to the afore-discussed figures, the present invention may employ a lossy compression, such as whereby data typically comprising an Internet html, xml, or like “page” is stripped of extraneous content and thereafter compressed. The definition of extraneous content may vary in embodiments of the present invention, such as at the direction of the user or of an implementer of the herein described systems and methods. Extraneous content may be or include one or more of: advertisements of one or more types, such as banner ads, springing ads, associative ads, or the like; all images or audio; high resolution images or audio; non-contextual images of any resolution; and the like. For example, such a page or pages may be stored as simply compressed text, may be stored as a compressed text and compressed associated low resolution images, may be stored as compressed text and all still images, and so on. Further, those skilled in the art will appreciate that data indicating a page stripped of extraneous content may be stored without additional compression. Needless to say, the more stripping of extraneous content and the more compression performed on the data, the greater the capability to store more of the data, and thus the greater the capability to transport more networked content off-network.

Thereby, the present invention lends itself readily to a variety of user-offerings. For example, a user may pay based on the content to be transported off-network, i.e., the user may make payment based on the amount of compression of the data performed. Additionally, the data available for transport may be categorized, such as to improve the herein described search capabilities, and a user may make payment based on one, the total number, the type, the extent, or the popularity of the data in the category chosen for transportability off-network.

Moreover, available offerings may vary by category. For example, categories that best lend to the highest compression, such as categories that are most readily consumed with text only (i.e., research sites, such as encyclopedic pages or the like), may be offered at a different level of compression than pages that do not lend to high compression as well (e.g., pages showing stills of categories from upcoming movies, along with reviews of the movies).

Additionally, it will be understood in light of the description herein that the user may elect to be subject to an on-line or off-line ad server, such as to lower or limit the cost of the data selected for transportability off-network. By way of example, a user may download, embedded with the data content for transport, certain advertisement content, such as advertisements embedded to spring during viewing of the content and targeted to the type of data content downloaded. For example, sports-related goods and services may be advertised, off-network, in conjunction with off-network viewing of sports-related data content pages. As such, premium and non-premium offerings may be made in accordance with the present invention, such as wherein a premium offering may not include advertisement content during off-network viewing.

The present invention may additionally, in a manner akin to Google's page crawling mechanism, provide for the availability of online or offline, stored page histories, such as of a user's favored pages, of most-visited pages by category, or the like. Additionally, unlike prior art solutions, such page histories may be time or date stamped, to thus indicate timing of a page “snapshot,” and such page histories may be bundled, such by a particular page, pages, domain, or topic of interest to the user, and may be obtained by that user for use off-network.

In additional exemplary embodiments of the present invention, the browsing history through the off-network data may be maintained, or similarly queued, for use online. That is, to the extent a user wishes to obtain or otherwise view the extraneous content removed to enable the transportability of the data in the present invention, the user may be able to obtain or otherwise view that removed content upon returning to a network connection by performing a “playback” of the off-network browsing history, by viewing the off-network pages that were queued and selecting the desired page for viewing on-line, or the like.

From the description herein throughout, a number of advantages of some embodiments of the condensed off-network archive of network content become evident. For people living in developing nations, most often for financial reasons, access is typically limited to the wealthy who can afford the necessary infrastructure in their homes. The condensed off-network archive of network content allows anyone with a compatible device to access the wealth and breadth of information available on the Internet.

Further, it is typical that when something is reduced in size a billion times, no useful material or structure will remain. However, in the case of the condensed off-network archive of network content, it has been found that useful information does remain, especially after the elimination of parts of the network that are not information-rich. In fact, it shows that a very large amount of useful, and more importantly, comparably thorough information is still present.

Moreover, the ability to store a local version of the Internet will allow travelers to access information with more convenience and less expense than can be done making special trips to public access portals or paying for data roaming on a mobile device. Additionally, citizens of countries with volatile governments will no longer be susceptible to state-shutdowns of Internet service in times of turmoil, as happened in Iran in 2009 and Egypt in 2011. As well, citizens will no longer be susceptible to government censorship of Internet content.

Intranets will become mobile and permissions for users will remain intact through the use of the present invention, allowing a person to view only what he is allowed to view on the regular network. Further, the filtering process means that many heterogeneous information sources will be converted into a uniform format, allowing for easy access and unprecedented analysis of information or content. Yet further, the filtering and selection of content will allow network administrators to create a tailored version for others using the condensed off-network archive of network content. As such, companies and parents would be able to effectively limit what content their employees or children are able to access while effectively preventing workaround solutions.

Accordingly, the various embodiments can be used to allow a person to browse the breadth of the Internet in an offline environment, remove extraneous content from web pages, and provide a safe, secure, and private browsing environment for any person wanting to browse the Internet from any location.

While the above description contains many specificities, these should not be construed as limitations on the scope of any embodiment, but as exemplifications of various embodiments thereof. Many other ramifications and variations are possible within the teachings of various embodiments. For example, a content-tailored version of the condensed off-network archive of network content may be created in order to provide more detailed information about, say, failed public transit systems in the state of Ohio, or any other general or specific topic, especially if additional video or image content is desired. Alternatively, it is possible that the condensed off-network archive of network content may forgo the indexing step in favor of having increased storage space available for more network content. Either an index may be generated externally or some other system of browsing the data may be implemented. Furthermore, it is conceivable that a crawler of the deep web may make available exponentially more information to users in an Internet scenario. Furthermore, it is conceivable that additional content could be added to the archive by a crawler while an intermittent connection is available to the otherwise off-network archive.

Accordingly, the scope should be determined by the appended claims and their legal equivalents, and not by the examples given.

What is claimed is:

1. A method of creating a data file of network content, comprising:
downloading a plurality of HTML webpages from a network, at least one of the webpages including text content and non-text content;
converting the plurality of HTML web-pages into unformatted text-only content;
compressing the unformatted text-only content; and
archiving the compressed unformatted text-only content;
wherein a desired webpage of the plurality of webpages can be obtained from the archive via decompression to provide a text-only version of the desired webpage.

2. The method of claim 1, further comprising:
comparing, for a downloaded page, a metric representing a usefulness of the download page against a threshold;
wherein downloaded pages that have a metric that exceed the threshold are subject to the archiving step.

3. The method of claim 1, further comprising:
comparing, for a downloaded page, a metric representing a usefulness of the download page against a threshold;
wherein downloaded pages that have a metric below the threshold are not subject to the archiving step.

4. The method of claim 1, further comprising:
comparing, for a downloaded page, a metric representing a usefulness of the download page against a threshold;
wherein downloaded pages that have a metric that exceed the threshold are subject to the archiving step;
wherein downloaded pages that have a metric below the threshold are not subject to the archiving step.

5. The method of claim 1, wherein the archive can be accessed without access to the network.

6. The method of claim 1, further comprising:
receiving a request for a desired web page;
locating the version of the desired web page in the archive; and
decompressing the located version of the desired web page;
wherein the decompression provides a text-only version of the desired webpage.

7. The method of claim 1, wherein repeated execution of the method produces a plurality of archives, the method further comprising:
receiving from a requestor a request for a desired web page; and
determining a most current version of the desired web page in the plurality of archives; and
providing the most current version of the desired web page to the requestor.

8. The method of claim 1, further comprising disconnecting the archive from the network.

9. A method of creating a data file of network content, comprising:
identifying a plurality of webpages from a network, at least one of the webpages including text content and non-text content;
converting the plurality of web-pages into text-only content;
compressing the text-only content; and
archiving the compressed text-only content;
wherein a desired webpage of the plurality of webpages can be obtained from the archive via decompression to provide a text-only version of the desired webpage.

10. The method of claim 9, further comprising:
comparing, for an identified webpage, a metric representing a usefulness of the download page against a threshold;
wherein identified pages that have a metric that exceed the threshold are subject to the archiving step.

11. The method of claim 9, further comprising:
comparing, for an identified page, a metric representing a usefulness of the download page against a threshold;
wherein downloaded pages that have a metric below the threshold are not subject to the archiving step.

12. The method of claim 9, further comprising:
comparing, for a downloaded page, a metric representing a usefulness of the download page against a threshold;
wherein downloaded pages that have a metric that exceed the threshold are subject to the archiving step;
wherein downloaded pages that have a metric below the threshold are not subject to the archiving step.

13. The method of claim 9, wherein the archive can be accessed without access to the network.

14. The method of claim 9, further comprising:
receiving a request for a desired web page;
locating the version of the desired web page in the archive; and
decompressing the located version of the desired web page;
wherein the decompression provides a text-only version of the desired webpage.

15. The method of claim 9:
wherein repeated execution of the method produces a plurality of archives,
the method further comprising:
receiving from a requestor a request for a desired web page; and
determining a most current version of the desired web page in the plurality of archives; and
providing the most current version of the desired web page to the requestor.

16. The method of claim 9, further comprising disconnecting the archive from the network.

17. A method of creating a data file of network content, comprising:
identifying a plurality of webpages from a network, at least one of the webpages including text content and non-text content;
determining which of the plurality of webpages are to be archived;
for those of the plurality of webpages to be archived, the method further comprises:
converting the webpages into text-only content;
compressing the text-only content; and
archiving the compressed text-only content;
wherein a desired webpage of the plurality of webpages can be obtained from the archive via decompression to provide a text-only version of the desired webpage.
for those of the plurality of webpages to be archived, at least the step of archiving is not performed.

18. The method of claim 17, wherein the determining comprises, for an identified webpage, comparing a metric representing a usefulness of the webpage against a threshold;

19. The method of claim 17, wherein the archive can be accessed without access to the network.

20. The method of claim 17, further comprising:
receiving a request for a desired web page;
locating the version of the desired web page in the archive; and
decompressing the located version of the desired web page;
wherein the decompression provides a text-only version of the desired webpage.

21. The method of claim 17:
wherein repeated execution of the method produces a plurality of archives,
the method further comprising:
receiving from a requestor a request for a desired web page; and
determining a most current version of the desired web page in the plurality of archives; and
providing the most current version of the desired web page to the requestor.

22. The method of claim 17 further comprising disconnecting the archive from the network.
